(19) United States
(12) Patent Application Publication
(10) Pub. No.: US 2013/0237187 A1
(43) Pub. Date: Sep. 12, 2013

(54) TERMINAL AND CONTROL METHOD FOR LOCATION INFORMATION SECURITY

(71) Applicant: PANTECH CO., LTD, Seoul (KR)

(72) Inventors: Sang Hui PARK, Seoul (KR); Min Hee KIM, Seoul (KR)

(73) Assignee: Pantech Co., Ltd., Seoul (KR)

(21) Appl. No.: 13/685,046

(22) Filed: Nov. 26, 2012

(30) Foreign Application Priority Data
Mar. 8, 2012 (KR) 10-2012-0023730

(51) Int. Cl. H04W 12/02

(52) U.S. Cl. CPC H04W 12/02
USPC 455/411

(57) ABSTRACT

A terminal and method for increasing security of location information, including: a modem including a GPS engine to process signals and control a GPS module, to perform voice and data communication; a software block connected to the modem and to application program(s) to provide a location information service, the software block to transmit a GPS signal and information to the modem and the application program; and a location information control module to detect a location information transmission request, or a GPS module activation instruction, to the modem or the software block, and to determine whether the location information transmission request, and the GPS module activation instruction, are authorized or unauthorized operations, and to allow or interrupt a fulfillment of the location information transmission request or the GPS module activation instruction according to the determination result. Accordingly, unauthorized transmission of location information may be decreased, thereby increasing security.

### CROSS-REFERENCE TO RELATED APPLICATION

This application claims priority to and the benefits under 35 U.S.C. §119 of Korean Patent Application No. 10-2012-0023730, filed on Mar. 8, 2012, the contents of which are herein incorporated in its entirety by reference for all purposes as if fully set forth herein.

### BACKGROUND

1. Field

Exemplary embodiments relate to a mobile communication terminal and control method for providing security against a leakage of location information and increasing location information security in a terminal.

2. Discussion of the Background

A Global Positioning System (GPS) has been originally developed to measure a location of a military vehicle, a vessel, an airport or the like. Since GPS is also useable for private purposes, GPS is used for navigation on vehicles, ships, helicopters or the like. Also, along with the propagation of smart terminals, which are intelligent cellular phones having a computer-supporting function in addition to general functions of a cellular phone, various GPS functions are being utilized.

For example, various kinds of service, such as a friend search service, a traffic report service and emergency service are provided as life services. In addition, various kinds of life information service is provided as, for example, a shortest public transportation route calculating and guiding service, a driving information service to promote safe driving, and customized information service for user-requested information such as to locate service stations and restaurants, or the like.

However, in such a location-based service, the technique or the ability to provide personal location information protection has not been satisfactorily addressed. For example, use of location based service may pose a risk in relation to dealing with the potential for invasion of personal privacy as may be caused by malicious use of a location based service by an unauthorized user who is not an authorized, permitted or granted user of a location based service. Moreover, issues as to the problem of potential human rights violations on personal privacy are possible, since a personal location may be traced due to a leakage of personal information or personal location information.

### SUMMARY

Exemplary embodiments relate to apparatus and methods for blocking unauthorized access to a terminal and location information of the terminal, to decrease unauthorized or illegal access to location information and personal information of a terminal, such as may occur without user knowledge.

Exemplary embodiments relate to a terminal to provide security against a leakage of location information, the terminal including: a software block to process a location information request; a modem connected to the software block to communicate information with the software block to process the location information request; and a location information control module to detect the location information request to the modem or the software block, to determine the location information request as an authorized request or an unauthorized request, and to allow or interrupt a fulfillment of the location information request based upon the determination.

Exemplary embodiments also relate to a method for providing security against a leakage of location information from a terminal, the method including: detecting a location information request by the terminal; determining by the terminal whether the detected location information request is an authorized request or an unauthorized request; processing the location information request based upon the determination that the location information request is an authorized request; and interrupting processing of the location information request based upon the determination that the location information request is an unauthorized request.

Exemplary embodiments further relate to a method for providing security against a leakage of location information from a terminal, the method including: processing a location information request by a software block to execute at least one application program associated with the location information request; communicating information by a modem to process the location information request by the software block; detecting the location information request to at least one of the modem or the software block by a location information control module; and determining by the location information control module the location information request as an authorized request or an unauthorized request, and to allow or interrupt processing of the location information request based upon the determination.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile communication terminal according to exemplary embodiments of the present invention.

FIG. 2 is a flowchart illustrating main control operations of a control method for a mobile communication terminal according to exemplary embodiments of the present invention.

FIG. 3 is a flowchart illustrating a control method for a mobile communication terminal based on a software block of FIG. 1 according to exemplary embodiments of the present invention.

FIG. 4 is a flowchart illustrating details of a control method for a mobile communication terminal of FIG. 1 according to exemplary embodiments of the present invention.

FIG. 5 is a flowchart illustrating a control method for a mobile communication terminal based on a modem of FIG. 1 according to exemplary embodiments of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present; and, as to wireless communication, may be interpreted as being wirelessly connected, such as a wireless connection between a terminal and a base station or external server, for example.

Hereinafter, a terminal may include, for example, a mobile communication terminal, handheld, portable or tablet computer or communication devices, and a method for location information security of the terminal, will be described in more detail with reference to the drawings, and should not be construed in a limiting sense. Also the terminal, and the modules of the terminal herein described, include hardware and software, and can also include firmware, to perform various functions of the terminal including those in location information security of the terminal, including those described herein, as may be known to one of skill in the art.

Also, a terminal may include, for example, any of various devices or structures used for wireless or wired communication of location information and personal information and can be wired or wireless connected to a base station, server or network, and may include another terminal, and also may include hardware, firmware, or software to perform various functions for decreasing a leak of location information or personal information, including those described herein, as may be known to one of skill in the art.

Hereinafter, a terminal, such as including, for example, a mobile terminal, a mobile communication terminal, handheld, portable or tablet computer or communication devices, and a method for increasing location information security of a terminal of a terminal will be described in more detail with reference to the drawings.

Generally, for example, a mobile device includes a hardware layer, such as including memory/storage and one or more processors, a platform for processing and transmitting a signal input at the hardware layer, and an application program layer having various application programs operated based on the platform.

The platform is classified into the Android™ platform, the Windows Mobile™ platform, the iOS™ platform or the like, depending on an operating system of a mobile device. And such platforms may have the same basic function even though they have somewhat different structures. A layer performing a specific function in such a platform is typically called a software block. For example, a software block in the Android™ OS may be a framework layer.

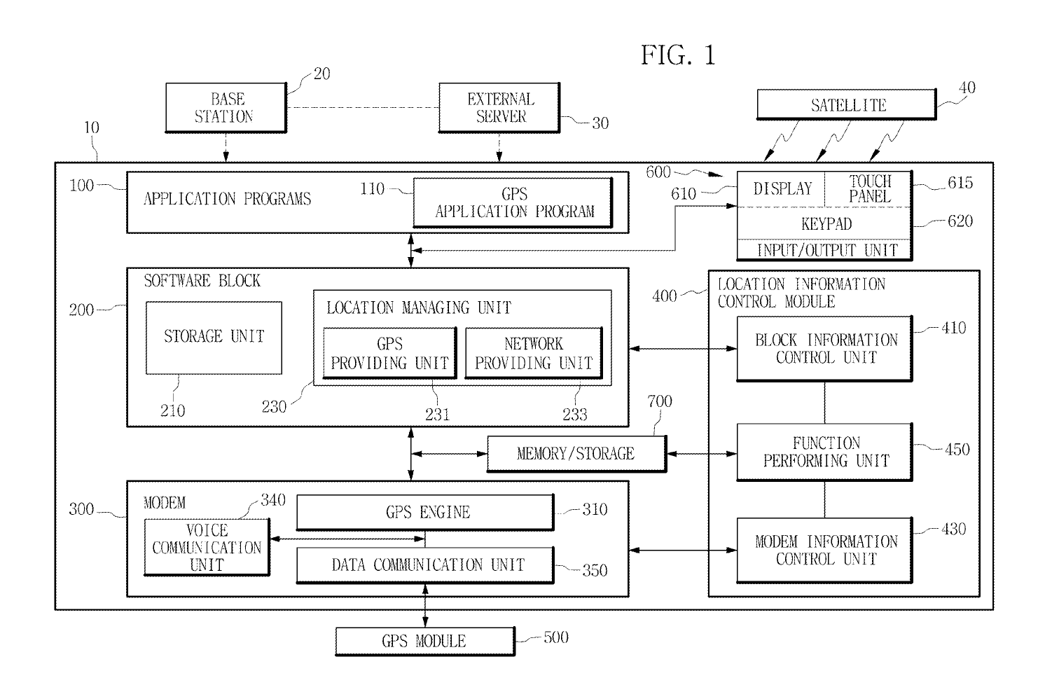

FIG. 1 is a block diagram showing a mobile communication terminal according to exemplary embodiments of the present invention.

Referring to FIG. 1, a mobile communication terminal 10 according to exemplary embodiments includes application programs 100 to provide various services and may include various application programs 110 capable of providing a Global Positioning Service (GPS) service or location information service (i.e., GPS application program 110), a modem 300 to perform voice and data communication, a software block 200 connected to the application programs 100, such as GPS application program 110, and the modem 300 to transmit a GPS signal and information to the application programs 100, such as GPS application program 110, and the modem 300, and a location information control module 400. The mobile communication terminal 10 includes a GPS module 500 to provide location information of the terminal 10. In addition the terminal 10 includes a GPS engine 310 for signal processing and control of the GPS module 500. Even though it is depicted that the GPS engine 310 is provided in the modem 300, the GPS engine 310 may be provided as a separate configuration, for example. Although features herein may be described with respect to GPS, for example, the GPS application program 110 and the GPS engine 310, aspects need not be limited thereto such that other location information systems may be similarly implemented and controlled.

The application programs 100 includes at least one application program which is executed on an operating system (OS) of the terminal 10 to provide predetermined information or a service to a user of the terminal 10. Among the one or more application programs, the GPS-associated application program 110 may include programs to enable using a positioning service, such as a map service and a friend search service, among the application programs 100. In a case where location information of the terminal 10 is needed, the GPS application program 110 provides the location information through the GPS module 500 to a user of the terminal 10 or a server, such as a server 30, associated with the application program.

The software block 200 detects a location information transmission request, or a GPS module activation instruction, from the GPS application program 110 and transmits the location information transmission request, or the GPS module activation instruction, to the modem 300. The software block 200 may also transmit an activation state of the GPS module 500 from the modem 300, the location information detected from the GPS module 500 or the like to the GPS application program 110.

In addition, the software block 200 includes a location managing unit 230 including a GPS providing unit 231 and a network providing unit 233. The GPS providing unit 231 transmits the location information transmission request or the GPS module activation instruction, received by the software block 200, to the modem 300, and receives GPS information from the modem 300 and transmits the GPS information to the GPS application program 110.

When location information of the terminal 10 is requested from a base station, such as a base station 20, of a mobile communication service provider or a network, the network providing unit 233 provides rough location information (for example, location information corresponding to an administrative district of the terminal 10.

The modem 300 includes a GPS engine 310 to perform signal processing and control of the GPS module 500, and a data communication unit 350 to perform data communication. The modem 300 also includes a voice communication unit 340 for voice communication by the terminal 10.

The GPS engine 310 is a module/processor to process a satellite signal and calculate or determine a coordinate for a GPS operation. And the driven GPS engine 310 receives a satellite signal, such as from a satellite 40, through the GPS module 500. In addition, the GPS engine 310 receives cell-based location information of the terminal 10 from a base station, such as the base station 20. The GPS engine 310 processes a satellite signal, such as from the satellite 40, and provides the generated GPS location information, namely GPS state information, such as latitude and longitude information, to the GPS providing unit 231. In addition, the GPS engine 310 provides the cell-based location information received from the base station 20 to the network providing unit 233.

The location information control module 400 includes a block information control unit 410 to monitor a location information transmission request, or a GPS module activation instruction, provided to the software block 200, a modem information control unit 430 to monitor a location information transmission request, or a GPS module activation instruction, provided to the modem 300, and a function performing unit 450 to determine the location information transmission request, or the GPS module activation instruction, based on the contents transmitted from the block information control unit 410 and the modem information control unit 430. The function performing unit 450 allows or interrupts fulfillment or processing of the location information transmission request, or the GPS module activation instruction, according to a determination result, such as whether the request is authorized, or allowed, or unauthorized, or not allowed, based on one or more determination criteria.

The terminal 10, including the application programs 100, the software block 200, the modem 300, and the location information control module 400 are associated with and may include any of various memory or storage media for storing software, program instructions, data files, data structures, and the like, and are associated with and may also include any of various processors, computers or application specific integrated circuits (ASICs) for example, to implement various operations to increase security of location information or personal information of the terminal 10, as described herein.

The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

The operation of the terminal 10 in association with a location information service is generally classified into two cases.

In a first case, the terminal 10 may request location information from the location information service. For example, in a case where a user of the terminal 10 executes the GPS application program 110 in order to use a GPS-associated function, the location information transmission request, or the GPS module activation instruction, is transmitted from the GPS application program 110 to the software block 200. The software block 200 transmits the requested location information transmission request, or GPS module activation instruction, to the modem 300. The modem 300 receives the request at the GPS engine 310 and activates the GPS module 500 to transmit the location information desired by the user of the terminal 10 to the software block 200 and provides the corresponding information through the software block 200 to the GPS application program 110 so that the user of the terminal 10 may receive the requested location information.

In a second case, an external server, such as the server 30, may request the terminal 10 to perform a GPS operation in order to recognize the location of a user of the terminal 10, or the location of the terminal 10. For example, the request of GPS information from a GPS server associated with the application program 110, a server of a mobile communication service provider, or other servers certified as being safe may be allowed by a user of the terminal 10. And according to the request of an allowed external server, the GPS information of the user of the terminal 10 may be provided to the corresponding external server, such as the server 30.

Where the modem 300 takes the lead of the operation of providing the location information to the location information service, the modem 300 collects the location information and provides the location information to the external server 30. In other words, the modem 300 receives a request of the external server 30 at the GPS engine 310, activates the GPS module 500, and transmits the location information to the external server 30. At approximately the same time, or after the location information is transmitted to the external server 30, the providing of the location information to the sever 30 is also provided to the software block 200, and the corresponding information may be provided to the user through the software block 200, such as on a display 610 of input/output unit 600 of the terminal 10.

In both the first and the second cases, after the location information transmission request, or the GPS module activation instruction, is fulfilled, the completion of the fulfillment of obtaining or sending the location information is provided to the user of the terminal 10, such as on the display 610 of input/output unit 600. However, in a case where the location information request is sent from the server 30 allowed by the user of the terminal 10, the fulfillment of obtaining and sending the location information to the server 30 may not be provided to the user of the terminal 10.

However, the location information, or personal information, of a user of the terminal 10 may leak out by a malicious access directed to the software block 200 or the modem 300, such as not through a normally authorized path. In a case of such an unauthorized operation, the operation of transmitting the fulfillment result of a location information transmission request or a GPS module activation instruction to the user through the software block 200 is interrupted in most cases, according to exemplary embodiments.

Therefore, to increase security of location information, or personal information, of the terminal 10, according to exemplary embodiments, monitoring is performed of the software block 200 and the modem 300 in GPS service operation. And, it is determined whether the location information service operation of the software block 200 and the modem 300 is an authorized operation, and then, if not an authorized operation, the location information service to obtain and provide location information, or personal information, may be stopped in a relatively short time, according to exemplary embodiments.

Hereinafter, a control method of the terminal 10 to increase location information security, such as to prevent or decrease a leak of location information, or personal information, by an access to the software block 200 and the modem 300 of the terminal 10 will be described in detail with reference to FIGS. 1 to 5, according to exemplary embodiments.

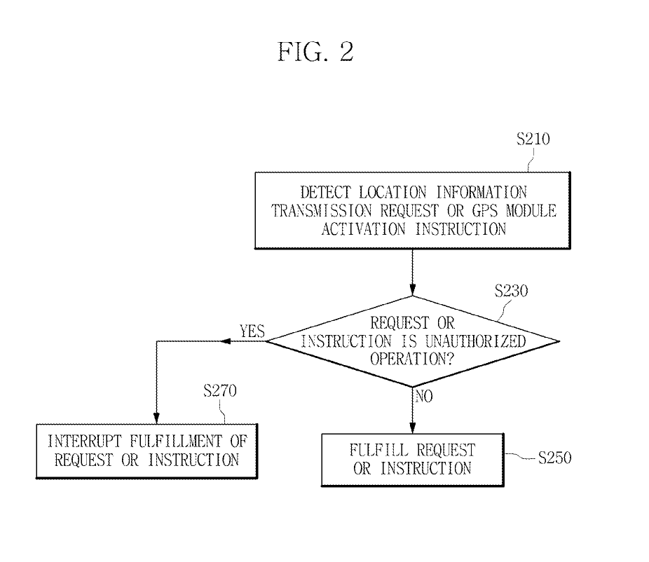

FIG. 2 is a flowchart illustrating main control operations of a control method for a mobile communication terminal according to exemplary embodiments of the present invention.

Referring to FIG. 2, if a location information transmission request, or a GPS module activation instruction, is requested and provided to the software block 200 or to the modem 300 such location information transmission request, or GPS module activation instruction is detected by the block information control unit 410 or the modem information control unit 430 at operation S210. The function performing unit 450 determines whether the corresponding request or instruction is an unauthorized operation at operation S230. If the location information transmission request, or the GPS module activation instruction, is an unauthorized operation, the fulfillment of the request or instruction is interrupted by function performing unit 450 at operation S270. If the request or instruction is an authorized operation, the request or instruction is fulfilled at operation S250.

By detecting a location information transmission request, or a GPS module activation instruction, provided to the software block 200 or to the modem 300, as described, an access of location information, or personal information through an abnormal or unauthorized path to the location information transmission request or GPS module activation instruction to the software block 200 and the modem 300 may be interrupted in advance, according to exemplary embodiments.

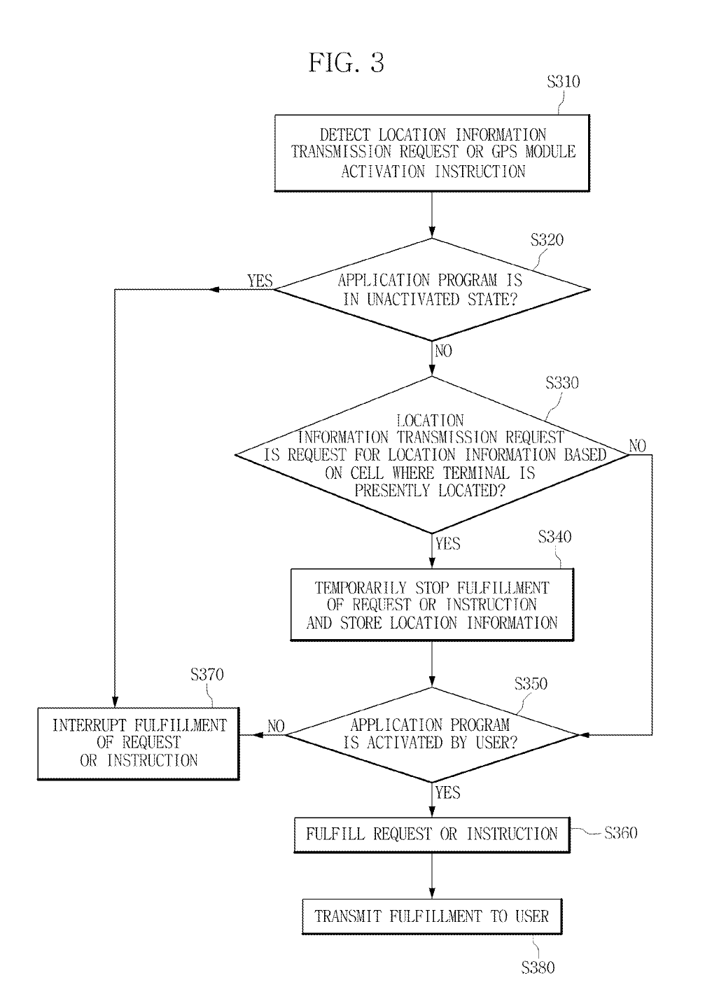

First, a case is described where location information, or personal information, leaks by a direct access to the software block 200 of the terminal 10. And methods for interrupting the leakage to decrease the leakage will be described with reference to FIG. 1 and then with reference to FIG. 3, according to exemplary embodiments.

In a first case where a user of the terminal 10 operates the GPS-associated application program 110, the application program 110 requests a location information transmission request, or a GPS module activation instruction, to the location managing unit 230 of the software block 200. The location managing unit 230 receives the request of the location information and operates the GPS providing unit 231 and the network providing unit 233 in relation to obtaining the location information.

The GPS providing unit 231 drives the GPS engine 310 of the modem 300, and the GPS engine 310 activates the GPS module 500 and obtains requested location information. The GPS location information and the GPS module activation information (information notifying that GPS module 500 turns on) received from the GPS engine 310 are provided to the GPS application program 110. In addition, the network providing unit 233 provides the cell-based location information received from the GPS engine 310 to the GPS application program 110.

The cell-based location information is location information roughly representing a location of the terminal 10 based on a cell and has typically less accuracy in comparison to the GPS location information. Since the terminal 10 is linked to the base station 20, in a case where the GPS engine 310 is operated, the base station 20 transmits the cell-based location information to the terminal 10. In addition, the cell-based location information may be more rapidly provided in comparison to the GPS location information. And the GPS engine 310 may process the cell-based location information within a shorter time in comparison to the GPS location information. The GPS providing unit 231 and the network providing unit 233 typically operate together, and the user may set the application program so that either or both of two kinds of information, such as the GPS location information and the cell-based location information, are provided.

As an example where the cell-based location information is required, if a user calls 911, an emergency phone number to call a fire station, for example, and intends to transmit the user's location of the terminal 10 to the fire station, rough location information may be rapidly transmitted using the cell-based information, even though this information may not be as accurate as GPS location information.

As described above, in a case where the terminal 10 requests a location information service, the software block 200 receives the location information from the modem 300 and provides the location information to the user, such as on the display 610 of the input/output unit 600 of the terminal 10. In this case, without user intervention, the location information control module 400 is operated to detect and interrupt, or stop, the operation of the software block 200, in association with the location information service, according to exemplary embodiments.

In determining whether the location information request is authorized, according to exemplary embodiments, the block information control unit 410 detects that the software block 200 starts an operation associated with the GPS location information providing service and transmits operation information to the function performing unit 450. In a case where the GPS application program 110 requests a location information transmission request, or a GPS module activation instruction, to the software block 200 and operates the location managing unit 230, it is detected whether the location managing unit 230 operates and whether the location managing unit 230 receives the request of the GPS application program 110.

Therefore, the information transmitted from the block information control unit 410 to the function performing unit 450 includes information about whether the GPS application program 110 operates, a time when the operation starts, information about whether the location managing unit 230 operates, or the like. The operation information of the location managing unit 230 includes information about whether the GPS providing unit 231 and the network providing unit 233 operate in relation to the location information request. When the location managing unit 230 is operating, both the GPS providing unit 231 and the network providing unit 233 operate in general cases, but the network providing unit 233 may not operate according to an application program setting of a user of the terminal 10. Based on the information, such as information about whether the GPS application program 110 operates, a time when the operation starts, information about whether the location managing unit 230 operates, or the like, the function performing unit 450 determines, such as based on these or other criteria, whether the location information transmission request or the GPS module activation instruction requested to the software block 200 is an authorized operation through a normal path or an unauthorized operation.

In a case where the block information control unit 410 detects the software block 200 and transmits operation information to the function performing unit 450, the function performing unit 450 starts determining whether the operation of the software block 200 in association with the location information service is a valid or authorized operation.

FIG. 3 is a flowchart illustrating a control method for a mobile communication terminal based on the software block 200 of FIG. 1 according to exemplary embodiments of the present invention.

As described in more detail with reference to FIG. 3, where the location information transmission request, or the GPS module activation instruction, is an authorized operation through a normal path, such as by a user of the terminal 10 executing the GPS application program 110, as well as a state where the user of the terminal 10 does not execute the GPS application program 110, or the software block 200 does not operate in association with the GPS location information service, can be determined, according to exemplary embodiments. In other words, if the GPS application program 110 is not in an activated state, this indicates that the software block 200 likely operates through an unauthorized path, as may be present, to improperly obtain location information of the terminal 10. And such unauthorized operation can be interrupted or stopped, to increase security of location information of the terminal 10, according to exemplary embodiments.

Therefore, referring to FIG. 3, in a case where a location information transmission request, or a GPS module activation instruction, requested and provided to the software block 200 is detected at operation S310, the function performing unit 450 determines whether the GPS-associated application program 110 is in an inactivated state at operation S320. And, if the GPS-associated application program 110 is in an inactivated state, the function performing unit 450 determines that the location information transmission request or the GPS module activation instruction is an unauthorized operation and interrupts, or stops, the request or instruction at operation S370.

In a case where the GPS application program 110 is in an activated state, the function performing unit 450 determines whether the location information transmission request is location information based on a cell where the terminal 10 is presently located at operation S330. In other words, the function performing unit 450 determines whether the network providing unit 233 to provide cell information of the terminal 10 is operating. Since the network providing unit 233 provides cell-based location information, it may operate faster than the GPS providing unit 231 which typically may provide a more accurate location. Therefore, in order to decrease cell-based location information of the terminal 10 from leaking, it is detected by the function performing unit 450 whether the network providing unit 233 is operating.

In a case where the network providing unit 233 operates according to a location information request requested and provided to the software block 200, the function performing unit 450 temporarily interrupts, or temporarily stops, a fulfillment of the location information transmission request, or the GPS module activation instruction. And the function performing unit 450 instructs the network providing unit 233 to store the cell-based location information in a storage unit 210 of the software block 200, or stored in or in conjunction with memory/storage 700 of the terminal 10, through the block information control unit 410 at operation S340. After that, the function performing unit 450 determines whether the activation of the GPS application program 110 is intended by the user of the terminal 10 at operation S350, according to exemplary embodiments.

In addition, in a case where the location information transmission request is not cell-based location information, such as where the location transmission request is a GPS module activation instruction, operation S350 is also performed by function performing unit 450, according to exemplary embodiments. This is because the network providing unit 233 may not operate in a case where the user of the terminal 10 sets the GPS application program 110 so that the cell-based location information is not provided.

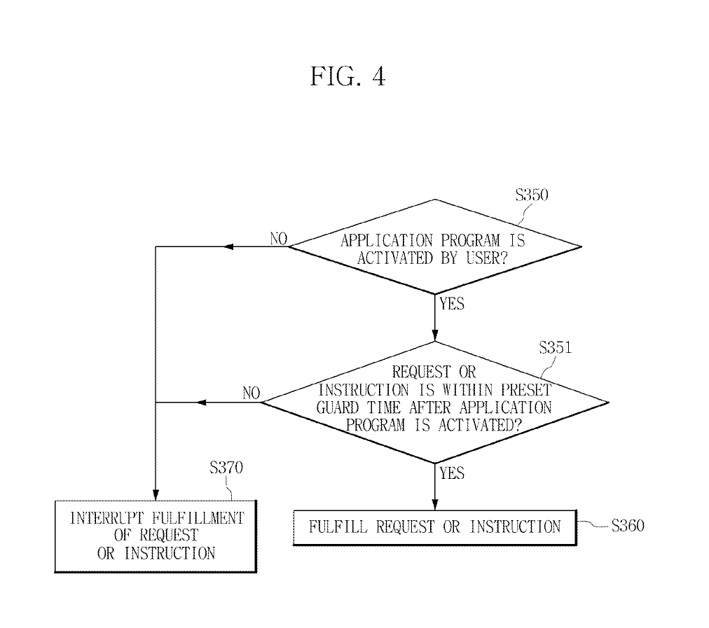

In operation S350, it is determined whether the GPS application program 110 determined as being activated in S320 is activated by the user of the terminal 10. For example, in a case where the GPS application program 110 is infected by a virus during downloading a file or application, the GPS application program 110 may operate by itself even though it is not executed by the user of the terminal 10. Therefore, according to exemplary embodiments, it is determined whether the operating GPS application program 110 is operated or executed by the user of the terminal 10. A method, according to exemplary embodiments, to determine operation or execution of the GPS application program 110 by the user of the terminal 10 will be described with reference to FIG. 4.

FIG. 4 is a flowchart illustrating details of a control method for a mobile communication terminal of FIG. 1 according to exemplary embodiments of the present invention.

Referring to FIG. 4, the function performing unit 450 sets a guard time, as an example of a criterion to determine an authorized location information request or instruction, and, after the at least one application program 100, such as GPS application program 110, is activated, determines whether a location information transmission request or a GPS module activation instruction is requested within the guard time at operation S351, the guard time being a preset time period or a reference time period, for example. If the request or instruction, such as a location information transmission request or a GPS module activation instruction, is requested within the guard time, the request or instruction is determined as authorized and fulfilled at operation S360 to provide the requested location information, and fulfillment of the request may be transmitted to the user of the terminal 10 at operation S380. But, if the request or instruction is not requested within the guard time, the fulfillment of the corresponding request or instruction is stopped or interrupted at operation S370, according to exemplary embodiments.

The above operation in relation to the exemplary embodiments of FIG. 4 may be described based on an actual example using a touch-input, such as to a touch panel 615 of input/output unit 600 of terminal 10, as follows.

First, it is determined whether the user touches the terminal 10, such as touching a key or keys of keypad 620 or touching the touch panel 615 of display 610 of the input/output unit 600. This is because the GPS application program 110 usually does not operate without the touch or input of the user entered on the terminal 10. In this case, a touch input signal of the user is input to a touch panel 615, which is usually hardware, but may include software and/or firmware, and the touch panel 615 input user touch is transmitted to the software block 200, and the transmitted touch input signal may be transmitted to the block information control unit 410, according to exemplary embodiments.

If the touch input of the user is detected, a touch parameter having a valid value or a true value is generated by the terminal 10, such as by the location information control module 400. After that, the block information control unit 410 transmits the touch parameter having the valid or true value and the touch time information, such as a time when the touch is input to the touch panel 615, to the function performing unit 450. The touch time information is used to determine whether the GPS application program 110 is executed by a touch input by a user of the terminal 10 to the touch panel 615, according to exemplary embodiments.

For example, when a user of the terminal 10 executes a MP3 application program, not associated with a GPS location information service, by a touch, such as by a touch input to touch panel 615, a location information transmission request or a GPS module activation instruction may also be requested by a malicious access or by an unauthorized operation, in conjunction with the MP3 request, regardless of the knowledge or intention of the user of the terminal 10. In general cases, if the user executes the GPS application program 110 intentionally, the GPS application program 110 will operate in a relatively short time after the touch input to the touch panel 615 or keypad input to keypad 620 of the terminal 10.

Therefore, in order to determine that the GPS application program 110 operation is authorized, such as by a touch input to touch panel 615 or to keypad 620 of input/output unit 600 of terminal 10, a gap of time or a time period between the touch time and the operating time of the GPS application program 110 in an authorized operation may be used as a reference criterion, for example, to determine if the requested location information request is authorized. In addition, the time gap may be automatically set in the terminal 10, such as stored in the memory/storage 700, or may be changed according to the user setting, such as entered on the touch panel 615 or keypad 620 of input/output unit 600 of the terminal 10. Since the operating time of the GPS application program 110 is included in the information transmitted to the block information control unit 410 in operation S320, the gap of time or time period between the touch time, the time when the user enters a touch input to the touch panel 615 or the keypad 620 of input/output unit 600 of terminal 10, and the operating time of the GPS application program 110 may be determined, and the determination result used to validate, if determined authorized, or invalidate, if determined unauthorized, the location information request.

In other words, the function performing unit 450 may determine whether the user of the terminal 10 provides a touch input to the input/output unit 600, such as by entering a touch input to the touch panel 615, by receiving the touch parameter having a true or valid value. And, the function performing unit 450 may determine whether the program, such as GPS application program 110, is executed in a normal or authorized path, such as by determining whether the location information transmission request or the GPS module activation instruction is requested within the guard time measured from the touch input time of the user of the terminal 10. If the location information transmission request or the GPS module activation instruction is not performed within the guard time from the touch input time of the user of the terminal 10, the execution is regarded as being performed in an abnormal or unauthorized path, and the fulfillment of the corresponding request or instruction is stopped or interrupted at operation S370.

If the location information transmission request or the GPS module activation instruction is requested within the guard time from the touch input time of the user of the terminal 10, the corresponding request or instruction is fulfilled to provide the requested location information at operation S360. After the corresponding request or instruction is fulfilled to provide the requested location information, the function performing unit 450 may change or reset the touch parameter value so that a new touch input to the terminal 10 may be detected, according to exemplary embodiments.

Through the above control process, a malicious or unauthorized attempt to access the software block 200 through an abnormal or unauthorized path and leaking the location information of the user may be interrupted or stopped, and thereby decreased, according to exemplary embodiments.

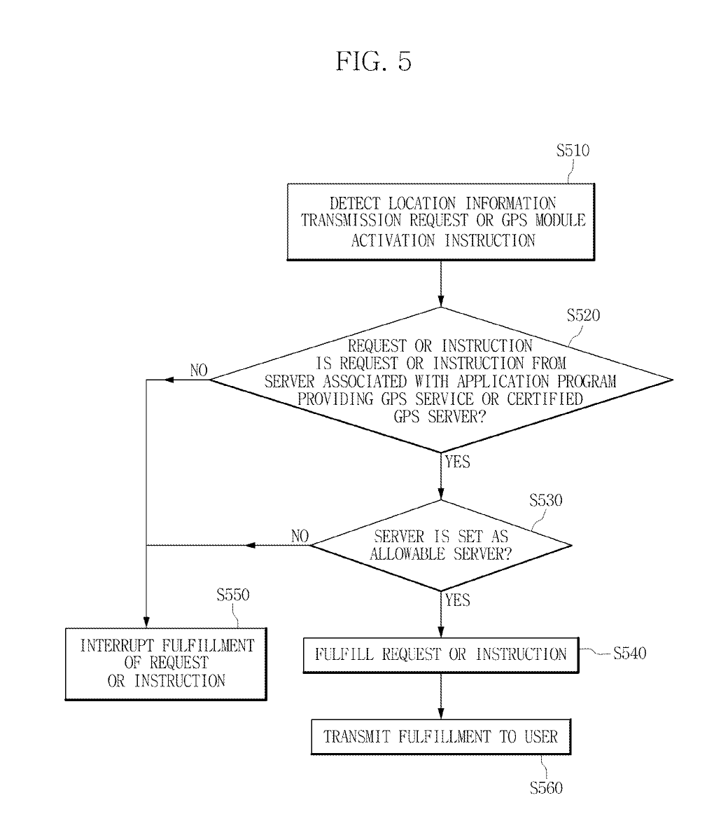

Hereinafter, a method for increasing location information security, such as by decreasing or preventing a leak of location information, by a direct access to the modem 300 of terminal 10 will be described with reference to FIG. 1 and FIG. 5, according to exemplary embodiments.

For an external server, such as server 30, to request location information to the modem 300, the data communication unit 350 typically operates to open a data call. A protocol used in a data call for general data communication may be a protocol having a default value, and a protocol used in a data call for a location information service may be a Secure User Plan Location (SUPL) protocol, for example.

In a case, such as where the SUPL protocol has not been corrupted or compromised, the modem 300 responds to a location information request from an external server, such as the server 30. The GPS module 500 receives GPS information from a satellite, such as the satellite 40, and receives cell-based location information from a base station, such as the base station 20. The received GPS information and cell-based location information are transmitted to the GPS engine 310 to calculate or determine a relatively accurate coordinate value, for the terminal 10. The calculated or determined coordinate value is provided through the data communication unit 350 to the external server, such as server 30. Therefore, the modem information control unit 430 and the function performing unit 450 operate to determine that the location information request from the server 30 is valid or authorized in order to promote preventing and to decrease a leak of the location information of the terminal 10 or the location information of the user of the terminal 10, such as by an access to the modem 300 of the terminal 10, according to exemplary embodiments.

In the foregoing exemplary operation to increase location information security of the terminal 10, according to exemplary embodiments, the modem information control unit 430 detects whether the modem 300 performs an operation associated with the GPS location information service. In other words, it is detected and determined whether a location information transmission request, or a GPS module activation instruction, is directly requested to the modem 300.

In a case where the modem 300 operates in association with the GPS location information service, the modem information control unit 430 transmits the operation information detected from the modem 300 to the function performing unit 450. The operation information of the modem 300 in association with the location information service, detected by the modem information control unit 430, includes information of a server, such as the server 30, which requests the location information transmission request or the GPS module activation instruction.

FIG. 5 is a flowchart illustrating a control method for a mobile communication terminal based on the modem 300 of FIG. 1 according to exemplary embodiments of the present invention.

Continuing with reference to FIG. 5, in a case where the function performing unit 450 detects that a location information transmission request, or a GPS module activation instruction, is requested from the modem information control unit 430 to the modem 300 at operation S510, the function performing unit 450 determines whether the corresponding request or instruction is the operation requested by a server, such as the server 30, associated with the GPS application program 110 providing GPS service or a certified GPS server at operation S520, according to exemplary embodiments.

In this regard, the GPS engine 310 may be operated by directly accessing the modem 300, such as by using a malicious code or socket, even though there is no request from the server 30. Therefore, in a case where the operation information transmitted from the modem information control unit 430 does not include information about the server 30, the function performing unit 450 determines that there is no authorized or valid request from the server 30 and interrupts or stops a fulfillment of the location information transmission request, or the GPS module activation instruction, at operation S550, according to exemplary embodiments.

In a case where the GPS application program 110 provides map or traffic information, the server 30 associated with the GPS application program 110 may be a server for the corresponding application program having a database (DB) about map or traffic information, for example. In addition, the certified GPS server may be a server for portal service, which is known and used and may provide GPS location information and map information, such as Google, Naver®, Daum®, or the like.

In a case where the location information transmission request, or the GPS module activation instruction, is determined as being sent from a server 30 associated with the application program or a certified GPS server, in other words, where information about an external server 30 is present, the function performing unit 450 determines once again whether the server 30 is an allowed server at operation S530, according to exemplary embodiments.

The allowed server refers to a server which is allowed for a user of terminal 10 to take location information, and in general cases, servers of mobile communication service providers and GPS servers, such as Google and Qualcomm®, may be regarded as allowed servers. The allowed server may be basically set or stored in the memory 700 of terminal 10 or may be changed by the user of the terminal 10, such as by an input to the touch panel 615 or keypad 620 of input/output unit 600, for example. A certified GPS server may be excluded from an allowed server list if the user of the terminal 10 does not want a request from the corresponding server. And a not-allowed server is not allowed for the transmission of location information and the fulfillment of a GPS module activation instruction, according to exemplary embodiments.

The function performing unit 450 has or is provided information of the allowed server in advance, or by user input to the touch panel 615 or the keypad 620 of the input/output unit 600, and determines whether the corresponding server is an allowed server by comparison with the server information received from the modem information control unit 430 at operation S530. As a result, in a case where the server 30 requesting the location information transmission request, or the GPS module activation instruction, is not an allowed server, the function performing unit 450 instructs the GPS engine 310 to stop or interrupt its operation through the modem information control unit 430. In other words, the fulfillment of the corresponding request or instruction is interrupted or stopped at operation S550, according to exemplary embodiments.

In a case where the server 30 requesting the location information transmission request, or the GPS module activation instruction, of the terminal 10 is an allowed server, the function performing unit 450 transmits the corresponding request or instruction to the data communication unit 350 so that the request or instruction is provided to the external server 30 to fulfill the request or instruction at operation S540. After that, the fulfillment result of the location information transmission request or the GPS module activation instruction is transmitted to the user at operation S560, such as by displaying the result on the display 610 or a sound output through the voice communication unit 340, for example.

As a result, an attempt to maliciously or improperly access the modem 300 directly and leaking the location information of the user may be interrupted or stopped, according to exemplary embodiments.

According to exemplary embodiments, since the unauthorized transmission of location information directly requested through a software block or a modem of a terminal may be stopped or interrupted, and effectively prevented, it may be possible to prevent a leak of location information, such as where a user of the terminal is unaware of has not agreed to transmission of the location information, and thereby enhance increased location information security of the terminal.

Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to provide security against a leakage of location information, the terminal comprising:
a software block to process a location information request;
a modem connected to the software block to communicate information with the software block to process the location information request; and
a location information control module to detect the location information request to the modem or the software block, to determine the location information request as an authorized request or an unauthorized request, and to allow or interrupt a fulfillment of the location information request based upon the determination.

2. The terminal of claim 1, wherein the software block is connected to an application program to implement a location information request based on the at least one application program.

3. The terminal of claim 1, wherein the location information control module comprises:
a function performing unit to determine the content of the location information request, to determine from the content of the location information request an authorized request or an unauthorized request, and to allow the location information request, when an authorized request, and to interrupt the location information request, when an unauthorized request.

4. The terminal of claim 1, wherein the location information control module comprises:
a block information control unit to process a location information request, the request including at least one of a location information transmission request or a global positioning system (GPS) module activation instruction to the software block;
a modem information control unit to process the location information request, the request including at least one of a location information transmission request or a GPS module activation instruction to the modem; and
a function performing unit to determine the content of the location information request received from at least one of the block information control unit or the modem information control unit, to determine the location information request as an authorized request or an unauthorized request, and to allow the location information request, when authorized, and to interrupt the location information request, when unauthorized.

5. The terminal of claim 1, wherein the software block comprises:
a location managing unit to transmit the location information request to the modem and to receive information from the modem in response to the location information request.

6. The terminal of claim 5, wherein the location managing unit comprises:
a global positioning system (GPS) providing unit to transmit the location information request to the modem; and
a network providing unit to provide rough location information of the terminal in response to the location information request.

7. The terminal of claim 1, wherein the modem comprises:
a global positioning system (GPS) engine to receive and process a GPS signal including information in response to the location information request, when received by the terminal, and to receive cell-based information of the terminal from a base station, when the base station is communicating with the terminal, in response to the location information request; and
a data communication unit to perform data communication to open a data call with an external server to receive and transmit information in response to the location information request.

8. The terminal of claim 7, wherein
the GPS engine determines from at least one of the GPS signal information or the cell-based information a coordinate value of the terminal corresponding to the location information request, and
the data communication unit provides the coordinate value to an external server in response to the location information request, when the location information request is determined as an authorized request by the determination of the location information control module.

9. The terminal of claim 7, wherein the modem further comprises:
a voice communication unit to perform voice communication by the terminal to provide information to or receive information from a user of the terminal in relation to the location information request.

10. The terminal of claim 1, wherein
the modem operates in association with a global positioning system (GPS) location information service in relation to the location information request, and
the location information control module receives operation information detected from the modem in relation to the location information request that includes information received from a server to request of the terminal at least one of a location information transmission request or a GPS module activation instruction.

11. The terminal of claim 1, further comprising:
at least one application program to execute by the terminal the location information request, and
wherein the application program is provided to the software block in response to the location information request to process the request.

12. The terminal of claim 11, wherein
the at least one application program provides at least one of a global positioning system (GPS) service or location information service to process the location information request.

13. The terminal of claim 1, wherein
the determination result is based on a guard time, and
the location information request is determined to be an authorized request when requested within the guard time.

14. The terminal of claim 1, further comprising:
at least one application program to process the information location request by the terminal, and
wherein the location information control module detects the location information request from a server and determines whether the server is associated with the at least one application program included in the application module.

15. The terminal of claim 14, wherein
the location information control module determines whether operation information transmitted with the location information request from the server includes information about the server, and determines the location information request to be an authorized request when the information about the server is included in the operation information, and determines the location information request to be an unauthorized request when the information about the server is absent from the operation information.

16. The terminal of claim of claim 14, wherein
the location information control module determines whether the server is an allowed server, based on information stored in the terminal, and if an allowed server, determines the location information request from the server as an authorized request.

17. A method for providing security against a leakage of location information from a terminal, the method comprising:
detecting a location information request by the terminal;
determining by the terminal whether the detected location information request is an authorized request or an unauthorized request;
processing the location information request based upon the determination that the location information request is an authorized request; and
interrupting processing of the location information request based upon the determination that the location information request is an unauthorized request.

18. The method of claim 17, further comprising:
processing the location information request, when authorized, based on an application program stored by the terminal associated with the location information request.

19. The method of claim 17, further comprising:
determining from at least one of global positioning system (GPS) signal information or cell-based information received by the terminal a coordinate value of the terminal corresponding to the location information request.

20. The method of claim 19, further comprising:
providing the coordinate value to an external server in response to the location information request, when the location information request is determined as an authorized request.

21. The method of claim 17, wherein
the determination is based on a guard time, and
the location information request is determined to be an authorized request when requested within the guard time.

22. The method of claim 17, further comprising:
determining whether the location information request is detected within a guard time measured from a touch input time of a touch input to the terminal, and
wherein the location information request is determined to be an authorized request when detected within the guard time.

23. The method of claim 22, wherein:
the touch input is an input to at least one of a touch panel of a display or a keypad of the terminal.

24. The method of claim 22, further comprising:
resetting the touch input time to detect a further touch input to the terminal associated with a further location information request to determine if the further location information request is an authorized request.

25. The method of claim 17, wherein
processing the location information request includes executing at least one application program by the terminal,
wherein the at least one application program is associated with the information requested by the information location request.

26. The method of claim 25, further comprising:
receiving the location information request from an external server; and
wherein the determination is based on whether the server is associated with the at least one application program.

27. The method of claim 17, further comprising:
determining whether operation information to process the location information request included with the location information request received from an external server includes information about the server, and
determining the location information request to be an authorized request when the information about the server is included in the received operation information, and determining the location information request to be an unauthorized request when the information about the server is absent from the received operation information.

28. The method of claim 17, wherein
the information location request includes a request for personal information of a user of the terminal.

29. A method for providing security against a leakage of location information from a terminal, the method comprising:
processing a location information request by a software block to execute at least one application program associated with the location information request;
communicating information by a modem to process the location information request by the software block;
detecting the location information request to at least one of the modem or the software block by a location information control module; and
determining by the location information control module the location information request as an authorized request or an unauthorized request, and to allow or interrupt processing of the location information request based upon the determination.
